(19) United States
(12) Patent Application Publication
(10) Pub. No.: US 2016/0110712 A1
(43) Pub. Date: Apr. 21, 2016

(54) METHOD AND SYSTEM FOR IDENTIFYING MERCHANT DESCRIPTORS FOR DECLINED TRANSACTIONS

(71) Applicant: MasterCard International Incorporated, Purchase, NY (US)

(72) Inventor: Justin X. HOWE, San Francisco, CA (US)

(73) Assignee: MASTERCARD INTERNATIONAL INCORPORATED, Purchase, NY (US)

(21) Appl. No.: 14/519,737

(22) Filed: Oct. 21, 2014

(51) Int. Cl. G06Q 20/40; G06Q 40/00

(52) U.S. Cl. CPC G06Q 20/40; G06Q 40/12

(57) ABSTRACT

A method for identifying merchant descriptors for a declined transaction includes: storing a plurality of authorization requests, each request corresponding to an approved transaction and including one or more merchant descriptors and transaction data; storing a plurality of clearing records, each record corresponding to a cleared payment transaction and including two or more merchant descriptors and transaction data; receiving a declined authorization request corresponding to a declined payment transaction, the declined request including at least one merchant descriptor; identifying a related authorization request where the included one or more merchant descriptors corresponds to the at least one merchant descriptor included in the declined request; identifying a specific clearing record that corresponds to the related authorization request based on correspondence between the transaction data in the specific clearing record and the related authorization request; and transmitting the two or more merchant descriptors included in the identified specific clearing record.

### FIELD

The present disclosure relates to the identifying of merchant descriptors for a declined transaction, specifically the use of a clearing record for an approved transaction having a corresponding authorization request related to same merchant involved in the declined transaction to identify additional merchant descriptors for the declined transaction.

### BACKGROUND

As part of the processing of a payment transaction, an authorization request is submitted to a payment network by a merchant or acquirer. The payment network then processes the authorization request for approval by the network itself and/or an issuer associated with a payment card used to pay for the transaction. If an authorization request is approved, the transaction is processed, funds are exchanged and accounts settled, and a clearing record is generated for the transaction in order for the merchant to receive the corresponding funds. As such, clearing records tend to be complete, with all merchant descriptors being present in order to facilitate payment. Declines often have incomplete merchant descriptors, which can be acceptable because a decline does not require the same level of detail as the merchant's identity since funds are not being transferred to the merchant. If an authorization request is declined, the merchant and acquirer are notified, and the consumer is free to provide different payment method or may quit the transaction. Payment transactions can be declined for a variety of reasons, such as an expired payment card, insufficient funds, an unapproved merchant or industry, suspected fraud, and more.

In some instances, a payment network may use declined transaction data, and may even purposefully decline a transaction, for reasons other than insufficient credit or funds. For example, a payment network may wish to identify a merchant due to suspicion that the merchant is engaging in, or otherwise associated with, the distribution of spam e-mail message, as described in detail in U.S. patent application Ser. No. 14/071,775, entitled “Method and System for Automated Detection of CAN-SPAM Violations by Merchants and Acquirers,” by Justin Xavier Howe, filed on Nov. 5, 2013, which is herein incorporated by reference in its entirety. As described in the above application, an authorization request may be submitted for the purchase of a good advertised in a spam message, in an attempt to identify the merchant and/or acquirer. The authorization request may then be declined, in order to prevent the purchase of the goods, which may be fraudulent or counterfeit, and to prevent the merchant from profiting due to the spam.

The declined authorization request may include one or more merchant descriptors, which may be used to identify the merchant involved in the transaction. However, the merchant descriptors included in an authorization request may often be unsuitable for detailed identification of a merchant. Thus, there is a need for a technical solution to identifying additional merchant descriptors for a declined transaction that uses minimal computing operations and storage compared to manually search for the additional data via database searches.

### SUMMARY

The present disclosure provides a description of systems and methods for identifying merchant descriptors for a declined transaction.

A method for identifying merchant descriptors for a declined transaction includes: storing, in an authorization database, a plurality of authorization requests, wherein each authorization request corresponds to an approved payment transaction and includes at least one or more merchant descriptors and transaction data; storing, in a clearing database, a plurality of clearing records, wherein each clearing record corresponds to a cleared payment transaction and includes at least two or more merchant descriptors and transaction data; receiving, by a receiving device, a declined authorization request corresponding to a declined payment transaction, wherein the declined authorization request includes at least one merchant descriptor; identifying, in the authorization database, an authorization request related to the merchant descriptor where at least one of the included one or more merchant descriptors corresponds to the at least one merchant descriptor included in the received declined authorization request; identifying, in the clearing database, a specific clearing record that corresponds to the identified related authorization request based on a correspondence between the transaction data included in the specific clearing record and the transaction data included in the identified related authorization request; and transmitting, by a transmitting device, the declined authorization request and the two or more merchant descriptors included in the identified specific clearing record.

Another method for identifying merchant descriptors for a declined transaction includes: storing, in an authorization database, a plurality of authorization requests, wherein each authorization request corresponds to an approved payment transaction and includes at least one or more merchant descriptors and transaction data; receiving, by a receiving device, a declined authorization request corresponding to a declined payment transaction, wherein the declined authorization request includes at least one merchant descriptor; identifying, in the authorization database, a related authorization request where at least one of the included one or more merchant descriptors corresponds to the at least one merchant descriptor included in the received declined authorization request; transmitting, by a transmitting device, a clearing record request, wherein the clearing record requests includes at least the transaction data included in the identified related authorization request; receiving, by the receiving device, a clearing record in response to the transmitted clearing record request, wherein the clearing record includes at least two or more merchant descriptors and transaction data that corresponds to the transaction data included in the identified related authorization request; and transmitting, by the transmitting device, the declined authorization request and the two or more merchant descriptors included in the received clearing record.

Another method for identifying merchant descriptors for a declined transaction includes: storing, in an authorization database, a plurality of authorization requests, wherein each authorization request corresponds to an approved payment transaction and includes at least one or more merchant descriptors and transaction data; storing, in a clearing database, a plurality of clearing records, wherein each clearing record corresponds to a cleared payment transaction and includes at least two or more merchant descriptors and transaction data; receiving, by a receiving device, a declined authorization request corresponding to a declined payment transaction, wherein the declined authorization request includes at least one merchant descriptor; identifying, in the authorization database, an authorization request related to the merchant descriptor where at least one of the included one or more merchant descriptors corresponds to the at least one merchant descriptor included in the received declined authorization request; identifying, in the clearing database, a group of clearing records that correspond to the identified related authorization request based on a correspondence between the transaction data included in the identified related authorization request and the transaction data included in each clearing record in the group of clearing records; identifying, by a processing device, at least one common merchant descriptor, wherein each common merchant descriptor is included in the two or more merchant descriptors included in each clearing record in the identified group of clearing records; and transmitting, by a transmitting device, the declined authorization request and the identified at least one common merchant descriptor.

A system for identifying merchant descriptors for a declined transaction includes an authorization database, a clearing database, a receiving device, a processing device, and a transmitting device. The authorization database is configured to store a plurality of authorization requests, wherein each authorization request corresponds to an approved payment transaction and includes at least one or more merchant descriptors and transaction data. The clearing database is configured to store a plurality of clearing records, wherein each clearing record corresponds to a cleared payment transaction and includes at least two or more merchant descriptors and transaction data. The receiving device is configured to receive a declined authorization request corresponding to a declined payment transaction, wherein the declined authorization request includes at least one merchant descriptor. The processing device is configured to: identify, in the authorization database, an authorization request related to the merchant descriptor where at least one of the included one or more merchant descriptors corresponds to the at least one merchant descriptor included in the received declined authorization request; and identify, in the clearing database, a specific clearing record that corresponds to the identified related authorization request based on a correspondence between the transaction data included in the specific clearing record and the transaction data included in the identified related authorization request. The transmitting device is configured to transmit the declined authorization request and the two or more merchant descriptors included in the identified specific clearing record.

Another system for identifying merchant descriptors for a declined transaction includes an authorization database, a receiving device, a processing device, and a transmitting device. The authorization database is configured to store a plurality of authorization requests, wherein each authorization request corresponds to an approved payment transaction and includes at least one or more merchant descriptors and transaction data. The receiving device is configured to receive a declined authorization request corresponding to a declined payment transaction, wherein the declined authorization request includes at least one merchant descriptor. The processing device is configured to identify, in the authorization database, an authorization request related to the merchant descriptor where at least one of the included one or more merchant descriptors corresponds to the at least one merchant descriptor included in the received declined authorization request. The transmitting device is configured to transmit a clearing record request, wherein the clearing record requests includes at least the transaction data included in the identified related authorization request. The receiving device is further configured to receive a clearing record in response to the transmitted clearing record request, wherein the clearing record includes at least two or more merchant descriptors and transaction data that corresponds to the transaction data included in the identified related authorization request. The transmitting device is further configured to transmit the declined authorization request and the two or more merchant descriptors included in the received clearing record.

Another system for identifying merchant descriptors for a declined transaction includes an authorization database, a clearing database, a receiving device, a processing device, and a transmitting device. The authorization database is configured to store a plurality of authorization requests, wherein each authorization request corresponds to an approved payment transaction and includes at least one or more merchant descriptors and transaction data. The clearing database is configured to store a plurality of clearing records, wherein each clearing record corresponds to a cleared payment transaction and includes at least two or more merchant descriptors and transaction data. The receiving device is configured to receive a declined authorization request corresponding to a declined payment transaction, wherein the declined authorization request includes at least one merchant descriptor. The processing device is configured to: identify, in the authorization database, an authorization request related to the merchant descriptor where at least one of the included one or more merchant descriptors corresponds to the at least one merchant descriptor included in the received declined authorization request; identify, in the clearing database, a group of clearing records that correspond to the identified related authorization request based on a correspondence between the transaction data included in the identified related authorization request and the transaction data included in each clearing record in the group of clearing records; and identify at least one common merchant descriptor, wherein each common merchant descriptor is included in the two or more merchant descriptors included in each clearing record in the identified group of clearing records. The transmitting device is configured to transmit the declined authorization request and the identified at least one common merchant descriptor.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the identification of merchant descriptors for a declined transaction in accordance with exemplary embodiments.

FIG. 2 is a block diagram illustrating the processing server of FIG. 1 for identifying merchant descriptors for a declined transaction in accordance with exemplary embodiments.

FIGS. 3A and 3B are a flow diagram illustrating a process for identifying merchant descriptors in a declined transaction in accordance with exemplary embodiments.

FIG. 4 is a diagram illustrating the identifying of additional merchant descriptors for a declined transaction using a related authorization request and associated clearing record in accordance with exemplary embodiments.

FIGS. 5-7 are flow charts illustrating exemplary methods for identifying merchant descriptors for a declined transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Identifying Merchant Descriptors

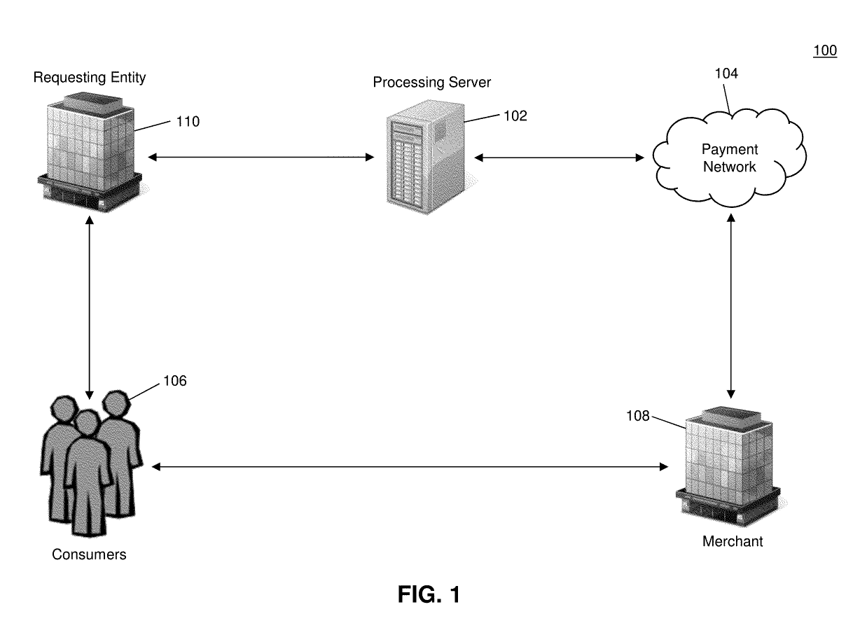

FIG. 1 illustrates a system 100 for the identification of merchant descriptors for a declined payment transaction.

The system 100 may include a processing server 102. The processing server 102, discussed in more detail below, may be configured to identify merchant descriptors for a declined payment transaction using the methods discussed herein. The processing server 102 may receive authorization requests for approved and declined transactions from a payment network 104, and may store the received authorization requests in an authorization database, as discussed below.

The payment network 104 may be configured to process payment transactions and may receive the authorization requests as part of the processing of payment transactions. For example, consumers 106 may conduct financial transactions with a merchant 108. As part of the transactions, the merchant 108 (e.g., or an acquirer associated with the merchant 108) may submit an authorization request for each payment transaction to the payment network 104.

The payment network 104 may process the payment transaction using methods and systems that will be apparent to persons having skill in the relevant art and return an authorization response to the merchant 108, which the merchant 108 may use to finalize the transaction. The payment network 104 may then transmit the authorization request and/or data included therein to the processing server 102 for storage. In some embodiments, the processing server 102 may be a part of the payment network 104. As part of the processing of the payment transactions, the payment network 104 may receive a clearing record for approved authorization requests, which may be stored by the payment network 104. In some embodiments, the clearing records may also be transmitted to the processing server 102.

The processing server 102 may identify an authorization request for a declined transaction for which additional merchant descriptors are to be identified. In some embodiments, the declined authorization request may be included in or indicated by a request submitted to the processing server 102 by a requesting entity 110. For example, the requesting entity 110 may be a government agency that wishes to identify a merchant engaging in fraud, and may provide or identify a declined authorization request for a transaction involving the merchant.

The processing server 102 may identify the authorization request for the declined transaction, which may include one or more merchant descriptors. The processing server 102 may then identify another authorization request for a different payment transaction that includes the same merchant descriptor(s), which may indicate that the different transaction involved the same merchant. The authorization request for the different transaction may be an approved authorization request for a process transaction that includes transaction data that may be used to identify a clearing record associated with the transaction, such as a reference number, bank identification number, transaction account number, payment account number, transaction time and/or date, transaction amount, response message, or other value or combination thereof suitable for the identification of a clearing record associated with an authorization request as will be apparent to persons having skill in the relevant art.

In embodiments where the processing server 102 may store clearing records, the processing server 102 may identify the associated clearing record using the transaction data. In other embodiments, the processing server 102 may submit a request to the payment network 104 with the authorization request and/or the included transaction data, and the payment network 104 may respond with the associated clearing record and/or the merchant descriptors included therein.

The processing server 102 may identify and/or receive a plurality of merchant descriptors included in the associated clearing record. The processing server 102 can then associate the plurality of merchant descriptors with the declined transaction, based on the correspondence between the declined authorization request and the approved authorization request. As a result, the processing server 102 may thereby possess a plurality of merchant descriptors for the declined transaction. In embodiments where the requesting entity 110 submitted a request identifying the declined transaction, the processing server 102 may transmit the merchant descriptors to the requesting entity 110 as a response to the request.

In some embodiments, a group of clearing records may match the identified authorization request. In such an instance, the clearing records in the group may include a variety of merchant descriptors. The processing server 102 may identify merchant descriptors that are common in the group of clearing records, which may then be transmitted on to the requesting entity 110. For example, a declined authorization request for a transaction may correspond to a number of clearing records for transactions involving the same merchant 108, but for different geographic locations. The processing server 102 may identify the merchant 108 as being in common and may transmit the common data. In instances where there may be no commonality among the clearing records, the processing server 102 may transmit an indication thereof that no additional descriptors could be identified.

In some instances, the systems and methods discussed herein may be performed using authorization requests for payment transactions that have not been approved or declined. For example, in instances where a group of clearing records may match a related authorization request, the additional merchant descriptor(s) may be identified prior to approval or denial of the payment transaction. In such an example, the additional descriptor(s) may be used for fraud modeling, which may be beneficial in the decision to approve or deny the payment transaction.

Methods and systems described herein may enable the processing server 102 to identify a plurality of merchant descriptors for a declined payment transaction that are not identified in the transaction's authorization request. By finding an authorization request for an approved transaction that is related in terms of the involved merchant, and identifying the merchant descriptors in its associated clearing record, the processing server 102 may quickly and efficiently identify the plurality of merchant descriptors using information that is already captured during transaction processing, without the need for modification to existing merchant or payment network systems. The processing server 102 may thus identify merchant descriptors for a declined transaction that may be otherwise unavailable, for the successful identification of a merchant in a declined transaction, which may be beneficial in a variety of applications, such as the identification of a merchant involved in fraud, the distribution of spam, or the production and/or sale of counterfeit merchandise.

### Processing Server

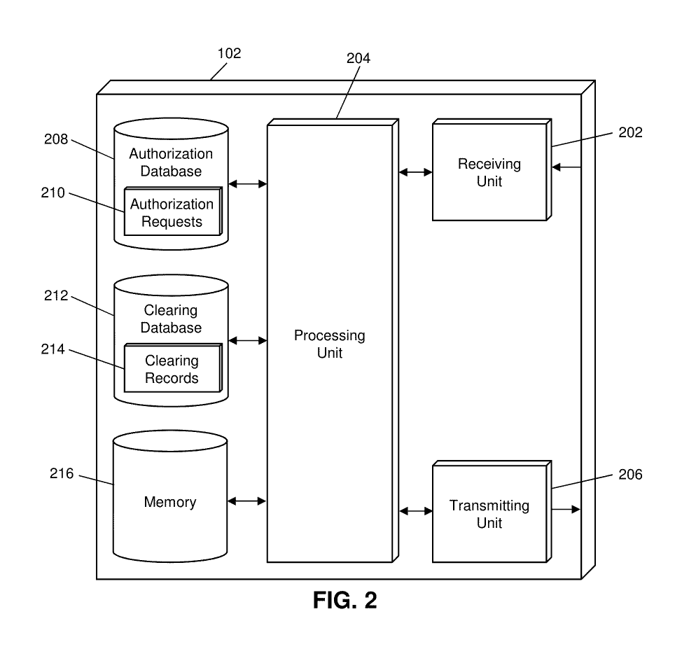

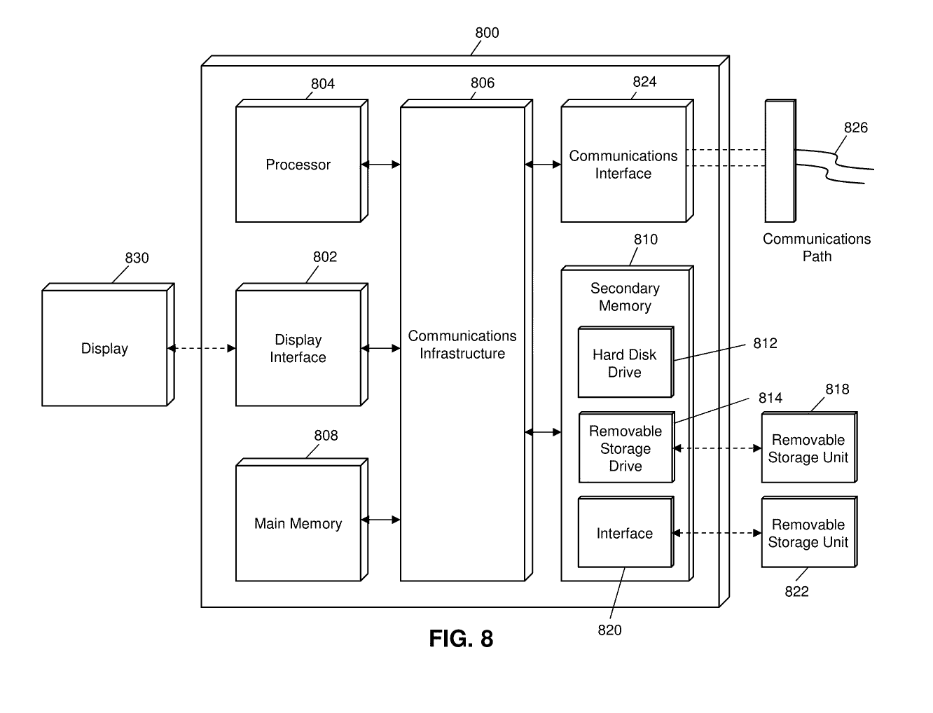

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive a plurality of authorization requests from the payment network 104 and/or from merchants or acquirers (e.g., in instances where the processing server 102 may be included in the payment network 104). The authorization requests may be stored in an authorization database 208 of the processing server 102 as authorization requests 210.

Each authorization request 210 may include one or more merchant descriptors and transaction data. Each merchant descriptor may be data associated with a merchant involved in the payment transaction related to the authorization request, such as a merchant name, doing business as name, legal name, street address, city, state, country, county, municipality, telephone number, zip code, postal code, tax identification number, merchant identification number, latitude and longitude, or other suitable type of descriptor as will be apparent to persons having skill in the relevant art. The transaction data may include data associated with the related payment transaction, such as a transaction amount, product data, merchant data, consumer data, transaction time and/or date, payment network reference number, acquirer reference number, merchant reference number, bank identification number, transaction account number, invoice number, etc. In some embodiments, each authorization request 210 stored in the authorization database 208 may be related to an approved payment transaction.

In some embodiments, the processing server 102 may also include a clearing database 212 for the storing of clearing records 214. The clearing records 214 may be received by the receiving unit 202 for storage in the clearing database 212 and may each be associated with an approved authorization request and related to an approved and processed payment transaction. Each clearing record 214 may include at least two or more merchant descriptors and transaction data. The two or more merchant descriptors may include at least the merchant descriptor(s) included in the associated authorization request as well as one or more additional merchant descriptors. The transaction data may include at least the transaction data included in the associated authorization request suitable for identification of the clearing record as corresponding to the same payment transaction.

The receiving unit 202 may also be configured to receive an authorization request corresponding to a declined payment transaction, such as from the requesting entity 110. The processing server 102 may further include a processing unit 204. The processing unit 204 may be configured to perform the functions of the processing server 102 as discussed herein as will be apparent to persons having skill in the relevant art. The processing unit 204 may identify one or more merchant descriptors included in the received authorization request, and may identify a related authorization request 210 stored in the authorization database 208 that includes the same one or more merchant descriptors. The identified related authorization request 210 may thus be related as involving the same merchant 108 in the respective corresponding payment transaction.

The processing unit 204 may also be configured to identify a clearing record 214 stored in the clearing database 212 that corresponds to the related authorization request 210 using the transaction data included in the authorization request 210 and clearing record 214. The processing unit 204 may be configured to identify the merchant descriptors included in the identified clearing record 214 and associate the merchant descriptors with the received authorization request for the declined transaction. In some embodiments, the processing unit 204 may be configured to identify a group of clearing records 214 stored in the clearing database 212 that correspond to the related authorization request 210. In such an embodiment, the processing unit 204 may further identify one or more merchant descriptors that are common in the two or more merchant descriptors included in each of the clearing records 214 in the identified group.

The processing server 102 may further include a transmitting unit 206. The transmitting unit 206 may be configured to transmit data over one or more networks via one or more network protocols. The transmitting unit 206 may transmit the identified merchant descriptors associated with the authorization request corresponding to the declined payment transaction. In embodiments where the processing server 102 may not include the clearing database 212, the transmitting unit 206 may also be configured to transmit the related authorization request 210 to the payment network 104 for use in identifying the associated clearing record. The receiving unit 202 may be configured to receive the associated clearing record from the payment network 104, which may then be used by the processing unit 204 for identification of the additional merchant descriptors.

The processing server 102 may also include a memory 216. The memory 216 may be configured to store data suitable for performing the functions disclosed herein. For example, the memory 216 may store rules regarding identifying a clearing record 214 associated with an authorization request 210, for identifying an authorization request 210 for an approved transaction related to a received authorization request for a declined transaction, etc.

It will be apparent to persons having skill in the relevant art that the processing server 102 may include additional components and/or that the components included in the processing server 102 as discussed herein may be configured to perform additional functions. For instance, in embodiments where the processing server 102 may be a part of the payment network 104, the components of the processing server 102 may be further configured to perform traditional functions of the payment network 104, such as for the processing of payment transactions.

### Process for Identifying Merchant Descriptors

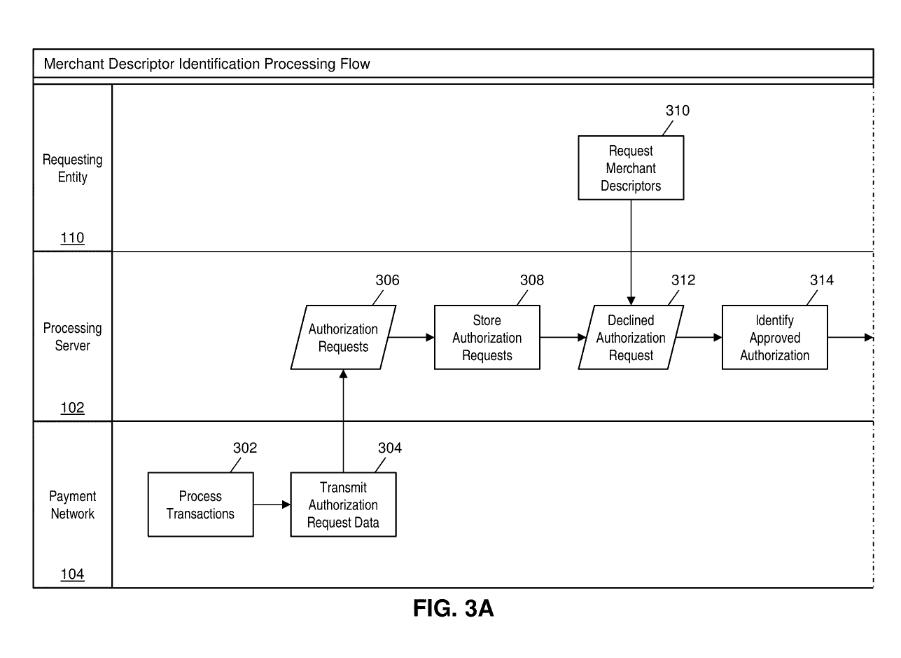

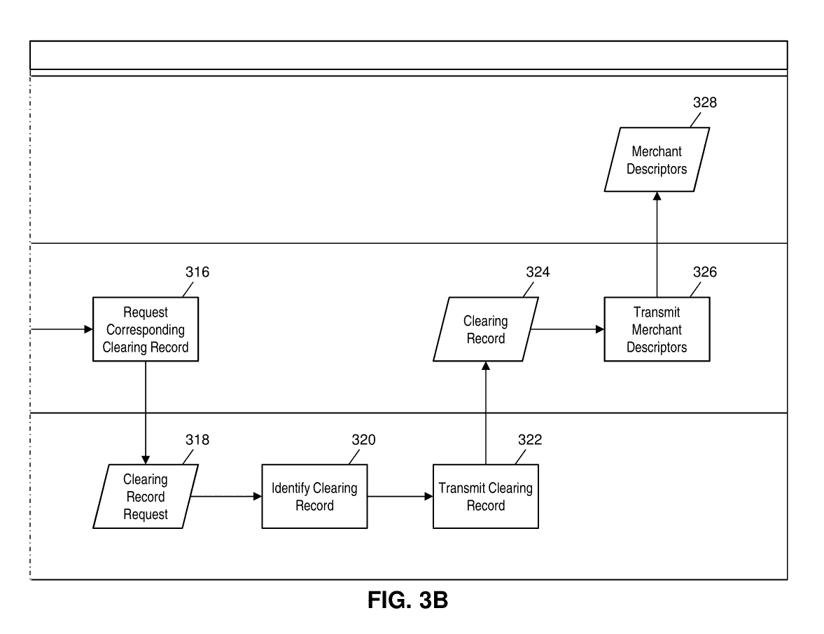

FIGS. 3A and 3B illustrate a process for the identification of merchant descriptors for a declined transaction using the system 100 of FIG. 1.

In step 302, the payment network 104 may process a plurality of payment transactions involving merchants 108 and consumers 106. As part of the processing of the payment transactions, the payment network 104 may receive and store authorization requests and clearing records for approved and processed transactions. In step 304, the payment network 104 may transmit the authorization requests to the processing server 102. In step 306, the receiving unit 202 of the processing server 102 may receive the authorization requests from the payment network 104.

In step 308, the processing unit 204 of the processing server 102 may store the received authorization requests as authorization requests 210 in the authorization database 208. Each authorization request 210 may include at least one or more merchant descriptors and transaction data. In step 310, a requesting entity 110 may transmit a request for merchant descriptors to the processing server 102. In step 312, the receiving unit 202 may receive the request, which may include an authorization request for a declined transaction, and may further include a plurality of requested merchant descriptors.

In step 314, the processing unit 204 may identify an authorization request 210 stored in the authorization database 208 for an approved transaction that involves the same merchant 108 as the received authorization request for the declined transaction. Identification of the approved authorization request 210 may include identifying an approved authorization request 210 that includes the same one or more merchant descriptors included in the received declined authorization request. In step 316, the transmitting unit 206 may transmit a request for a corresponding clearing record to the payment network 104, which may include the approved authorization request 210 and/or transaction data included therein.

In step 318, the payment network 104 may receive the request for a clearing record and may, in step 320, identify a clearing record that is associated with the approved authorization request 210 based on the transaction data included therein. Once the corresponding clearing record has been approved, then, in step 322, the payment network 104 may transmit the clearing record to the processing server 102. In step 324, the receiving unit 202 may receive the corresponding clearing record. The received clearing record may include at least two or more merchant descriptors, including at least one merchant descriptor not included in the approved authorization request 210.

In step 326, the transmitting unit 206 may transmit the two or more merchant descriptors to the requesting entity 110. In step 328, the requesting entity 110 may receive the two or more merchant descriptors, which may therefore be descriptors associated with a merchant involved in the declined transaction and may include one or more additional descriptors not found in the authorization request for the declined transaction.

### Identifying of Additional Merchant Descriptions for a Declined Authorization

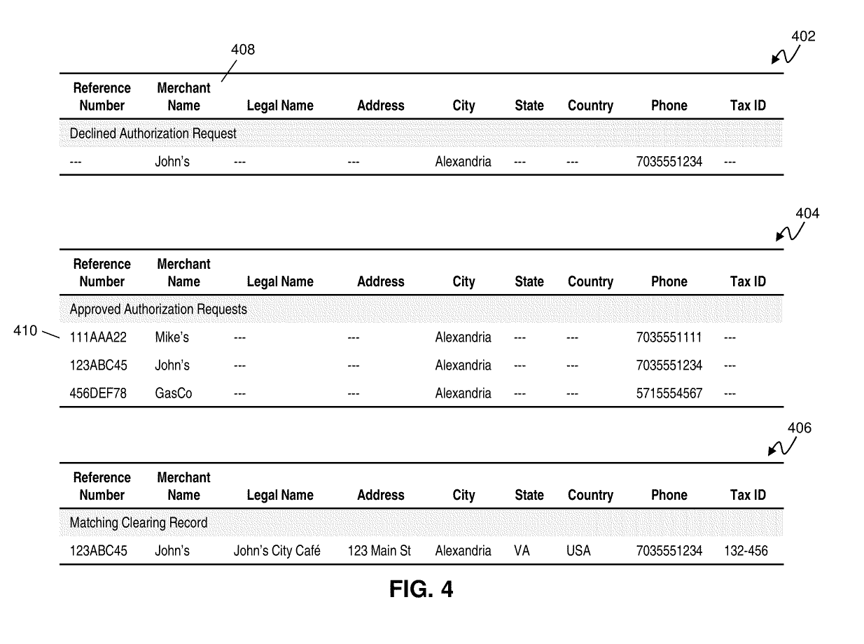

FIG. 4 illustrates the identification of additional merchant descriptors for an authorization request for a declined transaction using the methods and systems discussed herein.

Table 402 illustrates an authorization request for a declined transaction, such as submitted by the requesting entity 110 and received by the receiving unit 202 of the processing server 102. The declined authorization request may include a one or more merchant descriptors 408. In the example illustrated in FIG. 4, the declined authorization request includes populated three merchant descriptors, a merchant name, a city, and a phone number.

Table 404 illustrates a plurality of authorization requests 210, such as the authorization requests 210 stored in the authorization database 208 of the processing server 102. Each authorization request 210 may be for an approved payment transaction and may also include one or more merchant descriptors 408. In the example illustrated in FIG. 4, each authorization request 210 includes the same merchant descriptors 408 as the declined authorization request. Each authorization request 210 may also include transaction data, which may include at least a reference number 410, such as a payment network reference number, acquirer reference number, merchant reference number, etc.

As discussed above, the processing unit 204 of the processing server 102 may be configured to identify an authorization request 210 that is related to the declined authorization request based on the included merchant descriptors. In the example illustrated in FIG. 4, the second authorization request 210 in table 404 may be identified by the processing unit 204 as being related to the declined authorization request, as each of the three merchant descriptors 408 match.

Table 406 illustrates a clearing record that matches the identified authorization request 210 for an approved transaction that relates to the declined authorization request. The clearing record may include a plurality of merchant descriptors 408, including merchant descriptors 408 that are not included in the corresponding authorization request 210. For instance, in the example illustrated in FIG. 4, the clearing record may include a merchant legal name, address, state, country, and tax identifier that are not included in the corresponding authorization request 210.

As discussed above, the processing unit 204 may associate the plurality of merchant descriptors in the clearing record of table 406 with the declined authorization request of table 402, using the methods discussed herein. The result is that a plurality of merchant descriptors 408 associated with the merchant involved in the declined transaction may be identified using the one or more merchant descriptors 408 actually included in the declined authorization request.

### First Exemplary Method for Identifying Merchant Descriptors for a Declined Transaction

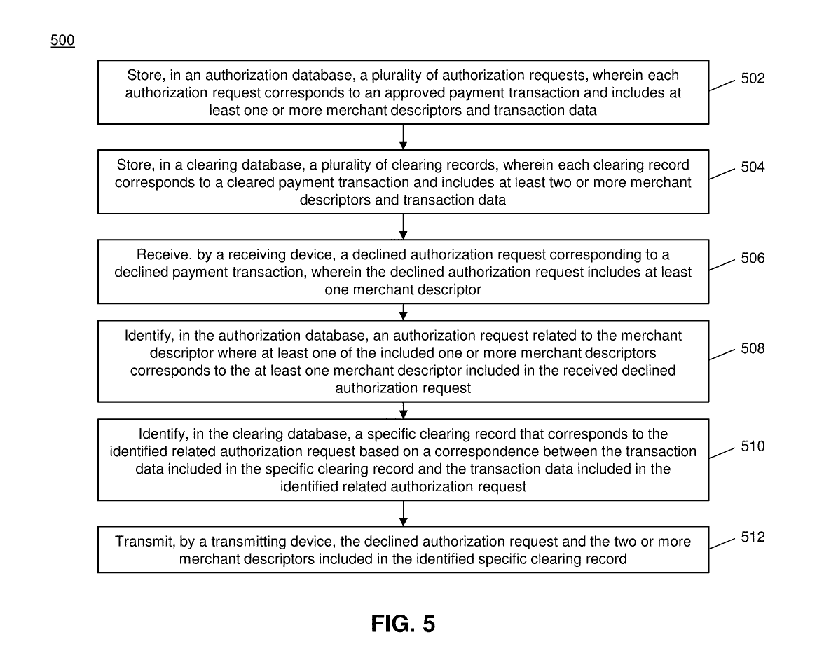

FIG. 5 illustrates a method 500 for identifying merchant descriptors for a declined transaction using a related authorization request and its corresponding clearing record.

In step 502, a plurality of authorization requests (e.g., authorization requests 210) may be stored in an authorization database (e.g., the authorization database 208), wherein each authorization request 210 corresponds to an approved payment transaction and includes at least one or more merchant descriptors and transaction data. In one embodiment, the transaction data may include at least one of: a payment network reference number, acquirer reference number, bank identification number, payment account number, transaction account number, transaction time and/or date, transaction amount, and response message. In some embodiments, merchant descriptors may include at least one of: merchant name, doing business as name, legal name, street address, city, state, country, county, municipality, telephone number, zip code, postal code, tax identification number, merchant identification number, and latitude and longitude.

In step 504, a plurality of clearing records (e.g., clearing records 214) may be stored in a clearing database (e.g., the clearing database 212), wherein each clearing record 214 corresponds to a cleared payment transaction and includes at least two or more merchant descriptors and transaction data. In step 506, a declined authorization request corresponding to a declined payment transaction may be received by a receiving device (e.g., the receiving unit 202), wherein the declined authorization request includes at least one merchant descriptor.

In step 508, a related authorization request 210 may be identified in the authorization database 208 where at least one of the included one or more merchant descriptors corresponds to the at least one merchant descriptor included in the received declined authorization request. In step 510, a specific clearing record 214 may be identified in the clearing database 212 that corresponds to the identified related authorization request 210 based on a correspondence between the transaction data included in the specific clearing record 214 and the transaction data included in the identified related authorization request 210.

In step 512, the declined authorization request and the two or more merchant descriptors included in the identified specific clearing record may be transmitted by a transmitting device (e.g., the transmitting unit 206). In one embodiment, the transmission may be for storage in the authorization database 208. In some embodiments, the declined authorization request may be received in a request for merchant descriptors, and the transmission may be transmitted in response to the received request for merchant descriptors.

### Second Exemplary Method for Identifying Merchant Descriptors for a Declined Transaction

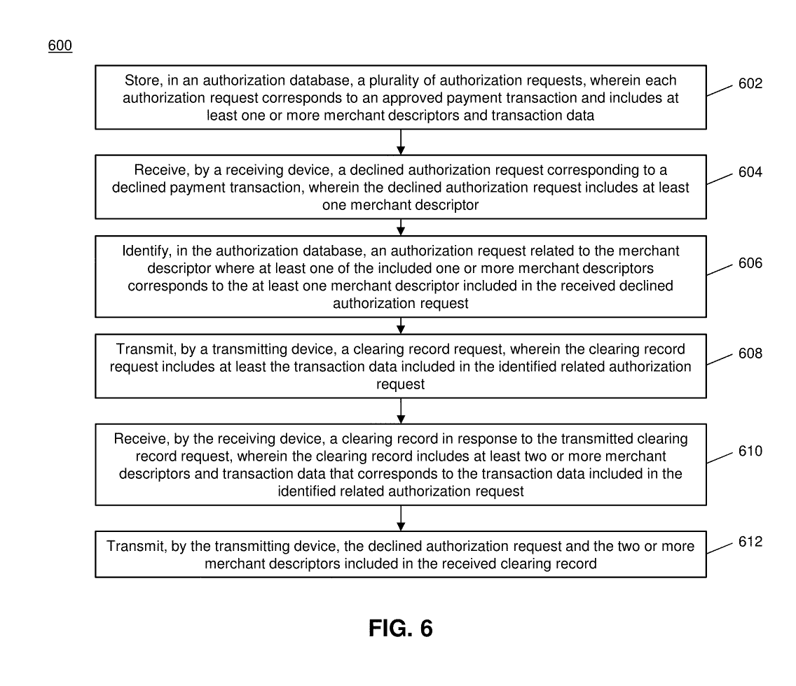

FIG. 6 illustrates a method 600 for identifying merchant descriptors for a declined transaction using a related authorization request and its corresponding clearing record.

In step 602, a plurality of authorization requests (e.g., authorization requests 210) may be stored in an authorization database (e.g., the authorization database 208), wherein each authorization request 210 corresponds to an approved payment transaction and includes at least one or more merchant descriptors and transaction data. In one embodiment, the transaction data may include at least one of: a payment network reference number, acquirer reference number, bank identification number, payment account number, transaction account number, transaction time and/or date, transaction amount, and response message. In some embodiments, merchant descriptors may include at least one of: merchant name, doing business as name, legal name, street address, city, state, country, county, municipality, telephone number, zip code, postal code, tax identification number, merchant identification number, and latitude and longitude.

In step 604, a declined authorization request corresponding to a declined payment transaction may be received by a receiving device (e.g., the receiving unit 202), wherein the declined authorization request includes at least one merchant descriptor. In step 606, a related authorization request 210 may be identified in the authorization database 208 where at least one of the included one or more merchant descriptors corresponds to the at least one merchant descriptor included in the received declined authorization request.

In step 608, a clearing record request may be transmitted by a transmitting device (e.g., the transmitting unit 206), wherein the clearing record request includes at least the transaction data included in the identified related authorization request. In step 610, a clearing record may be received, by the receiving device 202, in response to the transmitted clearing record request, wherein the clearing record includes at least two or more merchant descriptors and transaction data that corresponds to the transaction data included in the identified related authorization request 210.

In step 612, the declined authorization request and the two or more merchant descriptors included in the identified specific clearing record may be transmitted by a transmitting device (e.g., the transmitting unit 206). In one embodiment, the transmission may be for storage in the authorization database 208. In some embodiments, the declined authorization request may be received in a request for merchant descriptors, and the transmission may be transmitted in response to the received request for merchant descriptors.

### Third Exemplary Method for Identifying Merchant Descriptors for a Declined Transaction

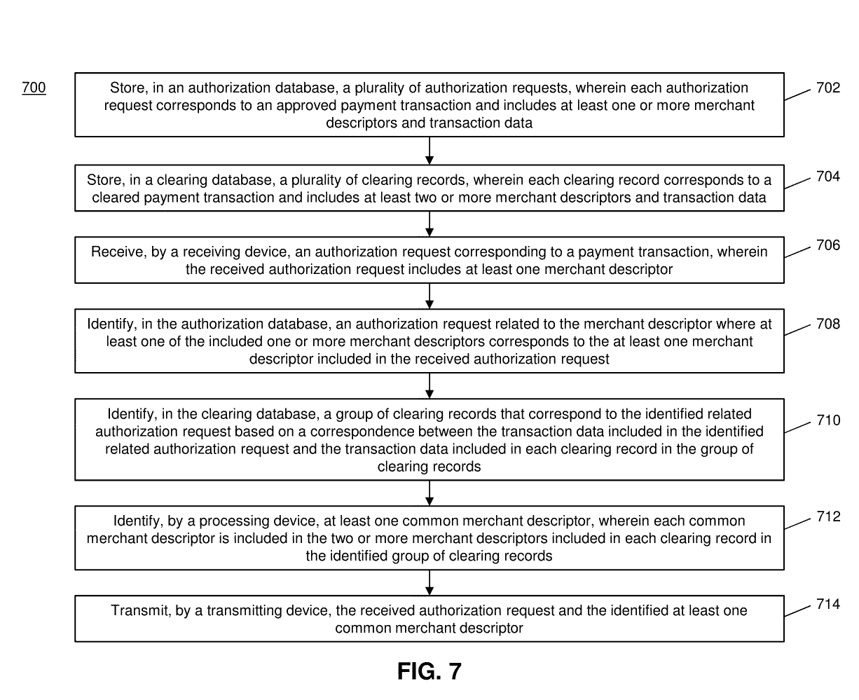

FIG. 7 illustrates a method 700 for identifying merchant descriptors for a declined transaction using a related authorization request and a corresponding group of clearing records.

In step 702, a plurality of authorization requests (e.g., authorization requests 210) may be stored in an authorization database (e.g., the authorization database 208), wherein each authorization request 210 corresponds to an approved payment transaction and includes at least one or more merchant descriptors and transaction data. In one embodiment, the transaction data may include at least one of: a payment network reference number, acquirer reference number, bank identification number, payment account number, transaction account number, transaction time and/or date, transaction amount, and response message. In some embodiments, merchant descriptors may include at least one of: merchant name, doing business as name, legal name, street address, city, state, country, county, municipality, telephone number, zip code, postal code, tax identification number, merchant identification number, and latitude and longitude.

In step 704, a plurality of clearing records (e.g., clearing records 214) may be stored in a clearing database (e.g., the clearing database 212), wherein each clearing record 214 corresponds to a cleared payment transaction and includes at least two or more merchant descriptors and transaction data. In step 706, an authorization request corresponding to a payment transaction may be received by a receiving device (e.g., the receiving unit 202), wherein the received authorization request includes at least one merchant descriptor.

In step 708, a related authorization request 210 may be identified in the authorization database 208 where at least one of the included one or more merchant descriptors corresponds to the at least one merchant descriptor included in the received authorization request. In step 710, a group of clearing records that correspond to the identified related authorization request may be identified in the clearing database 212 based on a correspondence between the transaction data included in the identified related authorization request and the transaction data included in each clearing record 214 in the group of clearing records.

In step 712, at least one common merchant descriptor may be identified by a processing device (e.g., the processing unit 204), wherein each common merchant descriptor may be included in the two or more merchant descriptors included in each clearing record 214 in the identified group of clearing records. In some embodiments, each of the at least one common merchant descriptors may not be included in the at least one merchant descriptor included in the received authorization request. In step 714, the received authorization request and the identified at least one common merchant descriptor may be transmitted by a transmitting device (e.g., the transmitting unit 206).

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 5-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3A, 3B, and 5-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for identifying merchant descriptors for a declined transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying merchant descriptors for a declined transaction, comprising:
storing, in an authorization database, a plurality of authorization requests, wherein each authorization request corresponds to an approved payment transaction and includes at least one or more merchant descriptors and transaction data;
storing, in a clearing database, a plurality of clearing records, wherein each clearing record corresponds to a cleared payment transaction and includes at least two or more merchant descriptors and transaction data;
receiving, by a receiving device, a declined authorization request corresponding to a declined payment transaction, wherein the declined authorization request includes at least one merchant descriptor;
identifying, in the authorization database, an authorization request related to the merchant descriptor where at least one of the included one or more merchant descriptors corresponds to the at least one merchant descriptor included in the received declined authorization request;
identifying, in the clearing database, a specific clearing record that corresponds to the identified related authorization request based on a correspondence between the transaction data included in the specific clearing record and the transaction data included in the identified related authorization request; and
transmitting, by a transmitting device, the declined authorization request and the two or more merchant descriptors included in the identified specific clearing record.

2. The method of claim 1, wherein the declined authorization request and the two or more merchant descriptors are transmitted for storing in the authorization database.

3. The method of claim 1, wherein the transaction data includes at least one of: a payment network reference number, acquirer reference number, bank identification number, payment account number, transaction account number, transaction time and/or date, transaction amount, and response message.

4. The method of claim 1, wherein the merchant descriptors include at least one of: merchant name, doing business as name, legal name, street address, city, state, country, county, municipality, telephone number, zip code, postal code, tax identification number, merchant identification number, and latitude and longitude.

5. The method of claim 1, wherein
the declined authorization request is received in a request for merchant descriptors, and
the two or more merchant descriptors included in the received clearing record are transmitted in response to the received request for merchant descriptors.

6. A method for identifying merchant descriptors for a declined transaction, comprising:
storing, in an authorization database, a plurality of authorization requests, wherein each authorization request corresponds to an approved payment transaction and includes at least one or more merchant descriptors and transaction data;
receiving, by a receiving device, a declined authorization request corresponding to a declined payment transaction, wherein the declined authorization request includes at least one merchant descriptor;
identifying, in the authorization database, an authorization request related to the merchant descriptor where at least one of the included one or more merchant descriptors corresponds to the at least one merchant descriptor included in the received declined authorization request;
transmitting, by a transmitting device, a clearing record request, wherein the clearing record requests includes at least the transaction data included in the identified related authorization request;
receiving, by the receiving device, a clearing record in response to the transmitted clearing record request, wherein the clearing record includes at least two or more merchant descriptors and transaction data that corresponds to the transaction data included in the identified related authorization request; and
transmitting, by the transmitting device, the declined authorization request and the two or more merchant descriptors included in the received clearing record.

7. The method of claim 6, wherein the declined authorization request and the two or more merchant descriptors are transmitted for storing in the authorization database.

8. The method of claim 6, wherein the transaction data includes at least one of: a payment network reference number, acquirer reference number, bank identification number, payment account number, transaction account number, transaction time and/or date, transaction amount, and response message.

9. The method of claim 6, wherein the merchant descriptors include at least one of: merchant name, doing business as name, legal name, street address, city, state, country, county, municipality, telephone number, zip code, postal code, tax identification number, merchant identification number, and latitude and longitude.

10. The method of claim 6, wherein
the declined authorization request is received in a request for merchant descriptors, and
the two or more merchant descriptors included in the received clearing record are transmitted in response to the received request for merchant descriptors.

11. A method for identifying merchant descriptors for a transaction, comprising:
storing, in an authorization database, a plurality of authorization requests, wherein each authorization request corresponds to an approved payment transaction and includes at least one or more merchant descriptors and transaction data;
storing, in a clearing database, a plurality of clearing records, wherein each clearing record corresponds to a cleared payment transaction and includes at least two or more merchant descriptors and transaction data;
receiving, by a receiving device, an authorization request corresponding to a payment transaction, wherein the received authorization request includes at least one merchant descriptor;
identifying, in the authorization database, an authorization request related to the merchant descriptor where at least one of the included one or more merchant descriptors corresponds to the at least one merchant descriptor included in the received authorization request;
identifying, in the clearing database, a group of clearing records that correspond to the identified related authorization request based on a correspondence between the transaction data included in the identified related authorization request and the transaction data included in each clearing record in the group of clearing records;
identifying, by a processing device, at least one common merchant descriptor, wherein each common merchant descriptor is included in the two or more merchant descriptors included in each clearing record in the identified group of clearing records; and
transmitting, by a transmitting device, the received authorization request and the identified at least one common merchant descriptor.

12. The method of claim 11, wherein each at least one common merchant descriptor is different from the at least one merchant descriptor included in the received authorization request.

13. A system for identifying merchant descriptors for a declined transaction, comprising:
an authorization database configured to store a plurality of authorization requests, wherein each authorization request corresponds to an approved payment transaction and includes at least one or more merchant descriptors and transaction data;
a clearing database configured to store a plurality of clearing records, wherein each clearing record corresponds to a cleared payment transaction and includes at least two or more merchant descriptors and transaction data;
a receiving device configured to receive a declined authorization request corresponding to a declined payment transaction, wherein the declined authorization request includes at least one merchant descriptor;
a processing device configured to
identify, in the authorization database, an authorization request related to the merchant descriptor where at least one of the included one or more merchant descriptors corresponds to the at least one merchant descriptor included in the received declined authorization request, and
identify, in the clearing database, a specific clearing record that corresponds to the identified related authorization request based on a correspondence between the transaction data included in the specific clearing record and the transaction data included in the identified related authorization request; and
a transmitting device configured to transmit the declined authorization request and the two or more merchant descriptors included in the identified specific clearing record.

14. The system of claim 13, wherein the declined authorization request and the two or more merchant descriptors are transmitted for storing in the authorization database.

15. The system of claim 13, wherein the transaction data includes at least one of: a payment network reference number, acquirer reference number, bank identification number, payment account number, transaction account number, transaction time and/or date, transaction amount, and response message.

16. The system of claim 13, wherein the merchant descriptors include at least one of: merchant name, doing business as name, legal name, street address, city, state, country, county, municipality, telephone number, zip code, postal code, tax identification number, merchant identification number, and latitude and longitude.

17. The system of claim 13, wherein
the declined authorization request is received in a request for merchant descriptors, and
the two or more merchant descriptors included in the received clearing record are transmitted in response to the received request for merchant descriptors.

18. A system for identifying merchant descriptors for a declined transaction, comprising:
an authorization database configured to store a plurality of authorization requests, wherein each authorization request corresponds to an approved payment transaction and includes at least one or more merchant descriptors and transaction data;
a receiving device configured to receive a declined authorization request corresponding to a declined payment transaction, wherein the declined authorization request includes at least one merchant descriptor;
a processing device configured to identify, in the authorization database, an authorization request related to the merchant descriptor where at least one of the included one or more merchant descriptors corresponds to the at least one merchant descriptor included in the received declined authorization request; and
a transmitting device configured to transmit a clearing record request, wherein the clearing record requests includes at least the transaction data included in the identified related authorization request, wherein
the receiving device is further configured to receive a clearing record in response to the transmitted clearing record request, wherein the clearing record includes at least two or more merchant descriptors and transaction data that corresponds to the transaction data included in the identified related authorization request, and
the transmitting device is further configured to transmit the declined authorization request and the two or more merchant descriptors included in the received clearing record.

19. The system of claim 18, wherein the declined authorization request and the two or more merchant descriptors are transmitted for storing in the authorization database.

20. The system of claim 18, wherein the transaction data includes at least one of: a payment network reference number, acquirer reference number, bank identification number, payment account number, transaction account number, transaction time and/or date, transaction amount, and response message.

21. The system of claim 18, wherein the merchant descriptors include at least one of: merchant name, doing business as name, legal name, street address, city, state, country, county, municipality, telephone number, zip code, postal code, tax identification number, merchant identification number, and latitude and longitude.

22. The system of claim 18, wherein
the declined authorization request is received in a request for merchant descriptors, and
the two or more merchant descriptors included in the received clearing record are transmitted in response to the received request for merchant descriptors.

23. A system for identifying merchant descriptors for a transaction, comprising:
an authorization database configured to store a plurality of authorization requests, wherein each authorization request corresponds to an approved payment transaction and includes at least one or more merchant descriptors and transaction data;
a clearing database configured to store a plurality of clearing records, wherein each clearing record corresponds to a cleared payment transaction and includes at least two or more merchant descriptors and transaction data;
a receiving device configured to receive an authorization request corresponding to a payment transaction, wherein the received authorization request includes at least one merchant descriptor;
a processing device configured to
identify, in the authorization database, an authorization request related to the merchant descriptor where at least one of the included one or more merchant descriptors corresponds to the at least one merchant descriptor included in the received authorization request,
identify, in the clearing database, a group of clearing records that correspond to the identified related authorization request based on a correspondence between the transaction data included in the identified related authorization request and the transaction data included in each clearing record in the group of clearing records, and
identify at least one common merchant descriptor, wherein each common merchant descriptor is included in the two or more merchant descriptors included in each clearing record in the identified group of clearing records; and
a transmitting device configured to transmit the received authorization request and the identified at least one common merchant descriptor.

24. The system of claim 23, wherein each at least one common merchant descriptor is different from the at least one merchant descriptor included in the received authorization request.
